(19) United States
(12) Patent Application Publication
(10) Pub. No.: US 2026/0321606 A1
(43) Pub. Date: Oct. 15, 2026

(54) NEGATIVE ELECTRODE SLURRY FOR A LITHIUM METAL BATTERY, A NEGATIVE ELECTRODE MANUFACTURED THEREFROM, AND A METHOD FOR MANUFACTURING THE SAME

(71) Applicants: HYUNDAI MOTOR COMPANY, Seoul (KR); KIA CORPORATION, Seoul (KR)

(72) Inventors: Jaekeun Nam, Hwaseong-si (KR); Sangheon Lee, Hwaseong-si (KR); Jihee Ham, Hwaseong-si (KR); Ju Yeong Seong, Hwaseong-si (KR); Seungjong Lee, Hwaseong-si (KR)

(73) Assignees: HYUNDAI MOTOR COMPANY, Seoul (KR); KIA CORPORATION, Seoul (KR)

(21) Appl. No.: 19/450,300

(22) Filed: Jan. 15, 2026

(30) Foreign Application Priority Data
Apr. 9, 2025 (KR) 10-2025-0045987

(51) Int. Cl. H01M 4/38; H01M 4/02; H01M 4/04; H01M 4/62; H01M 4/66; H01M 10/0525

(52) U.S. Cl. CPC H01M 4/38; H01M 4/0404; H01M 4/043; H01M 4/623; H01M 4/625; H01M 4/661; H01M 10/0525; H01M 2004/027

(57) ABSTRACT

A negative electrode slurry includes a negative electrode active material including a lithium powder, a conductive material, a binder, and a metal powder. The metal powder includes silver powder.

### CROSS-REFERENCE TO RELATED APPLICATION

This application claims priority to and the benefit of Korean Patent Application No. 10-2025-0045987 filed with the Korean Intellectual Property Office on Apr. 9, 2025, the entire contents of which are incorporated herein by reference.

### TECHNICAL FIELD

The present disclosure relates to a negative electrode slurry for a lithium metal battery, a negative electrode manufactured therefrom, and a method of manufacturing the same.

### BACKGROUND

lithium and lithium-ion secondary or rechargeable batteries are used in specific applications such as mobile phones, camcorders, and laptop computers, and more recently, even in higher power applications such as electric vehicles and hybrid electric vehicles. In these applications, the rechargeable batteries have the highest possible specific capacity, but it is desirable to keep providing safe operation conditions and excellent cyclability, so that the rechargeable batteries may maintain the high specific capacity over the subsequent recharge and discharge cycles.

There are lots of various configurations (constructions) for the rechargeable batteries, but each configuration includes a positive electrode (or cathode), a negative electrode (or anode), a separator separating the cathode and the anode, and an electrolyte electrochemically communicating with the cathode and the anode (e.g., allowing ionic movement between the cathode and anode). For the rechargeable lithium batteries, lithium ions, when the rechargeable batteries are discharged, move from the anode to the cathode through the electrolyte. During the discharge, electrons are collected from the anode and pass through an external circuit to the cathode. When the rechargeable batteries are charged or recharged, the lithium ions move from the cathode through the electrolyte to the anode.

Historically, the rechargeable lithium batteries have been manufactured by using a non-lithiated compound with a high specific capacity, for example, TiS₂, MoS₂, MnO₂ and V₂O₅ as cathode active materials. These cathode active materials were connected to a lithium metal anode. When the rechargeable batteries were discharged, lithium ions moved from the lithium metal anode through the electrolyte to the cathode. Unfortunately, the lithium metal generated dendrites during the cycling, which ultimately led to unsafe conditions in the batteries. As a result, these types of rechargeable batteries discontinued in the early 1990s in favor of lithium-ion batteries.

The lithium-ion batteries typically use a lithium metal oxide, for example, LiCoO₂ and LiNiO₂ as cathode active materials (which are connected to active anode materials such as carbon-based materials. It is recognized that there may be other anode types based on a silicon oxide, silicon particles, and the like. The batteries using a carbon-based anode system are substantially prevented from the lithium dendrite formation on the anode, which makes the batteries safer. However, electrochemically active lithium (whose amount determines battery capacity) is fully supplied from the cathode. Accordingly, a cathode active material must contain removable/cyclic lithium, which limits in selecting the cathode active material. In addition, delithiated products, which correspond to LiₓCoO₂ and LiₓNiO₂ formed during the charge and overcharge, are not stable. In particular, these delithiated products tend to react with an electrolyte and thus generate heat, which raises safety concerns.

The lithium-ion cells or batteries are initially in a discharged state. During the first charge of the lithium-ion cells, lithium moves from the cathode material to an anode active material. The lithium moving from the cathode to the anode reacts with an electrolyte material on the surface of the graphite anode, forming a passivation film on the anode. The passivation film formed on the graphite anode is a solid electrolyte interface (SEI). During the subsequent discharge, the lithium consumed by the SEI formation does not return to the cathode. This, because some of the lithium is consumed by the SEI formation, resultantly makes the lithium-ion cells have lower capacity than the initial charge capacity. This partial consumption of available lithium in the first cycle reduces the capacity of the lithium-ion cells. This phenomenon is referred to as irreversible capacity, wherein the lithium ion cells is known to consume greater than about 10% to about 20% of the capacity. Accordingly, after the initial charge of the lithium-ion cells, the lithium-ion cells lose greater than about 10% to about 20% of the capacity.

One solution is to pre-lithiate the anode by using stabilized lithium metal powder. For example, lithium powder may be stabilized by passivating the surface of the metal powder with carbon dioxide. The CO₂ passivated lithium metal powder may be used only in air at low moisture levels for a limited period of time before its lithium metal content is reduced due to a reaction between the lithium metal and the air. Another solution is to coat the lithium metal powder, for example, with fluorine, wax, phosphorus, or a polymer.

The statements in this Background section merely provide background information related to the present disclosure and may not constitute prior art.

### SUMMARY

Adding carbon to a slurry including the lithium metal powder has been proposed to further improve performance. However, when adding carbon to a slurry including the lithium metal powder was actually applied to lithium metal batteries, there still occurred nonuniform lithium electrodeposition and desorption.

Experimental results have shown that this is improved by adding a metal such as silver along with a conductive material to additionally provide conductivity.

The present disclosure provide a negative electrode slurry for a lithium metal battery, a negative electrode manufactured therefrom, and a negative electrode for a lithium metal battery including the same.

According to an embodiment, a negative electrode slurry for a lithium metal battery includes: a negative electrode active material including lithium powder; a conductive material; a binder; and a metal powder. The metal powder may include silver powder.

According to another embodiment, a negative electrode for a lithium metal battery may be manufactured using the negative electrode slurry.

According to another embodiment, a method for manufacturing a negative electrode for a lithium metal battery may include: coating the negative electrode slurry on a current collector; drying the negative electrode slurry coated on the current collector to form a coating layer; and compressing the coating layer.

According to yet another embodiment, a negative electrode for a lithium metal battery, the negative electrode include the negative electrode slurry.

According to the present disclosure, a lithium foil having electrochemical properties superior to those of the prior art is provided by introducing a conductive carbon-metal composite together with a lithium metal powder. Further, a negative electrode slurry for a lithium metal battery, a negative electrode for a lithium metal battery including the same, and a method for manufacturing the same are provided.

The negative electrode slurry for a lithium metal battery according to an embodiment may have superior electrochemical properties because more uniform electrodeposition and desorption of lithium occur than that in the prior art.

### BRIEF DESCRIPTION OF THE DRAWINGS

FIG. 1 is a Scanning Electron Microscope (SEM) image of the negative electrode surface (after 10 cycles) to which the negative electrode slurry according to Comparative Example 5 was applied.

FIG. 2 is an SEM image of the negative electrode surface (after 10 cycles) to which the negative electrode slurry according to Example 1 was applied.

FIG. 3 is an SEM image of the negative electrode surface (after 10 cycles) to which the negative electrode slurry according to Example 2 was applied.

FIG. 4 is an SEM image of the negative electrode surface (after 10 cycles) to which the negative electrode slurry according to Example 3 was applied.

FIG. 5 is an SEM image of the negative electrode surface (after 10 cycles) to which the negative electrode slurry according to Comparative Example 1 was applied.

FIG. 6 is an SEM image of the negative electrode surface (after 10 cycles) to which the negative electrode slurry according to Comparative Example 2 was applied.

FIG. 7 is an SEM image of the negative electrode surface (after 10 cycles) to which the negative electrode slurry according to Comparative Example 3 was applied.

FIG. 8 is an SEM image of the negative electrode surface (after 10 cycles) to which the negative electrode slurry according to Comparative Example 4 was applied.

FIG. 9 is an SEM image (fresh state) of the negative electrode surface to which the negative electrode slurry according to Comparative Example 5 was applied.

FIG. 10 is an SEM image (fresh state) of the negative electrode surface to which the negative electrode slurry according to Example 1 was applied.

FIG. 11 is an SEM image (fresh state) of the negative electrode surface to which the negative electrode slurry according to Example 2 was applied.

FIG. 12 is an SEM image (fresh state) of the negative electrode surface to which the negative electrode slurry according to Example 3 was applied.

FIG. 13 is an SEM image (fresh state) of the negative electrode surface to which the negative electrode slurry according to Comparative Example 1 was applied.

FIG. 14 is an SEM image (fresh state) of the negative electrode surface to which the negative electrode slurry according to Comparative Example 2 was applied.

FIG. 15 is an SEM image (fresh state) of the negative electrode surface to which the negative electrode slurry according to Comparative Example 3 was applied.

FIG. 16 is an SEM image (fresh state) of the negative electrode surface to which the negative electrode slurry according to Comparative Example 4 was applied.

FIG. 17 is an SEM image of a negative electrode after complete discharge using a lithium metal battery cell in which a negative electrode slurry according to Example 2 is applied.

FIG. 18 is an Energy Dispersive Spectroscopy (EDS) image of a negative electrode after complete discharge using a lithium metal battery cell in which a negative electrode slurry according to Example 2 is applied.

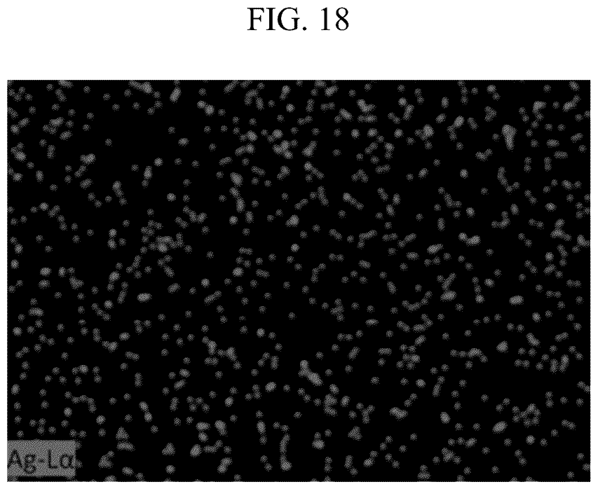

The drawings described herein are for illustration purposes only and are not intended to limit the scope of the present disclosure in any way.

### DETAILED DESCRIPTION

Special terms used herein is for the purpose of describing embodiments only and are not intended to be limiting of the present disclosure. The singular forms used herein include the plural forms as well, unless the context clearly indicates otherwise. The term “including,” “having,” or “comprising” used in the specification means that a specific feature, region, integer, step, operation, element and/or component is embodied and other specific features, regions, integers, steps, operations, elements, and/or components are not excluded.

Unless defined otherwise, all terms including technical and scientific terms used herein have the same meaning as commonly understood by those having ordinary skill in the art to which the present disclosure belongs. Commonly used predefined terms are further interpreted as having a meaning consistent with the relevant technical literature and the present disclosure, and are not to be construed as ideal or very formal meanings unless defined otherwise.

Terms including “first,” “second,” “third,” and the like are used for describing various arts, components, regions, layers, and/or sections, but are not limited thereto. These terms are only used to distinguish any part, component, region, layer, or section from the other part, component, region, layer, or section. Accordingly, the first part, component, region, layer, or section described below may be mentioned as the second part, component, region, layer, or section within the range without departing from the range of the present disclosure.

Also, unless specifically stated otherwise, % means wt %, and if no unit is specified separately, the unit based on weight is omitted.

As used herein, the term “combination(s) thereof” described in the expression in the Makushi format refers to one or more mixtures or combinations selected from the components described in the expression in the Markush format, and refers to including at least one selected from the components. In the present disclosure, each of phrases such as “A or B”, “at least one of A and B”, “at least one of A or B”, “A, B or C”, “at least one of A, B and C”, “at least one of A, B or C” and “at least one of A, B, or C, or a combination thereof” may include any one or all possible combinations of the items listed together in the corresponding one of the phrases.

Hereinafter, embodiments are described in detail. However, these embodiments are examples, and this disclosure is not limited thereto.

### Negative Electrode Slurry for Lithium Metal Battery and Method of Manufacturing the Same

In the present disclosure, by controlling the composition of a slurry for manufacturing a negative electrode active material for a lithium metal battery, the problem of non-uniform lithium electrodeposition and desorption of a negative electrode manufactured from a conventional slurry of a negative electrode active material for a lithium metal battery may be solved.

A negative electrode slurry for a lithium metal battery according to an embodiment includes: a negative electrode active material including a lithium powder; a conductive material; a binder; and a metal powder. The metal powder includes a silver powder.

A lithium metal negative electrode may be manufactured by coating a slurry containing lithium metal powder on a current collector such as copper foil, and carbon may be added to increase electrical conductivity between lithium particles. However, the problem is that uneven electrodeposition and desorption inevitably occur when the lithium anode is manufactured and applied to a battery cell. Therefore, the reaction occurs only in the initially electrochemically activated region, and unused lithium remains, preventing uniform use of the entire electrode. In an embodiment, since a structure is formed by simultaneously introducing metal (for example, silver) and carbon, more uniform electrodeposition and desorption of lithium occurs than in the prior art. Since it can be sufficiently implemented by mixing the metal powder and carbon and pulverizing them (ball mill, bead mill, and the like) or by using commercialized metal nanoparticle products, it may have high commerciality.

In the past, a method has been proposed to deposit a metal such as magnesium on a lithium thin film to form an alloy or to deposit the alloy itself, but there are significant disadvantages in manufacturing, such as the addition of a process step. However, as in an embodiment, the method of adding metal powder during the manufacture of a negative electrode slurry makes it possible to distribute it over the entire area, not just the upper surface of the lithium, which is very significant, for example, in terms of configuration compared to the prior art.

The silver powder may have an average particle diameter in a range of 50 nm to 200 nm. By controlling the average particle size of the above silver powder, cycle-life of a lithium metal battery manufactured using the same may be further improved.

For example, the silver powder may be included in an amount of 1 wt % or more, for example, 3 wt % or more, for example, in a range of 1 wt % to 5 wt %, for example, 3 wt % to 5 wt %, based on a total amount of solids constituting the negative electrode slurry for the lithium metal battery. By controlling the amount of the silver powder as described above, cycle-life improvement effect of a lithium metal battery manufactured using the same may be maximized.

The lithium metal powder in the negative electrode active material may have an average particle diameter in a range of 50 μm to 150 μm. The average particle size of the lithium powder in the negative electrode active material may be controlled as above to prevent the lithium available capacity from decreasing.

Based on the total amount (100 wt %) of the negative electrode slurry for the lithium metal battery, the negative electrode active material may be included in an amount in a range of 60 wt % to 99 wt %, for example, 70 wt % to 90 wt %.

The conductive material may be used to impart conductivity (e.g., electrical conductivity) to the electrode. Any material that does not cause chemical change (e.g., does not cause an undesirable chemical change in the rechargeable lithium battery) and conducts electrons may be used in the battery. Specific examples may include graphite such as natural graphite or artificial graphite; a carbon-based material such as carbon black, a carbon nanotube, acetylene black, Ketjen black, channel black, furnace black, lamp black, summer black, and a carbon fiber, which may be used alone or in a mixture of two or more. For example, it may be carbon black. If the conductive material includes a metal powder or a metal fiber such as copper, nickel, aluminum, or silver; a conductive whisker such as zinc oxide or potassium titanate; a conductive metal oxide such as titanium oxide; or conductive polymer such as polyphenylene derivative, it may be difficult to improve electrical conductivity between lithium particles.

According to an embodiment, a negative electrode slurry for a lithium metal battery is manufactured by introducing carbon during the process in which a negative electrode active material including lithium powder forms secondary particles from primary particles. At this time, as the carbon content increases, carbon is disposed between crystals, thereby lowering particle strength, and thus, by destroying the particles during the compression process after coating and drying, it becomes possible to manufacture an electrode with a high electrode density.

Specifically, when the carbon-based conductive material such as the carbon black is included in an amount exceeding 20 wt % based on the total amount (100 wt %) of the negative electrode slurry for the lithium metal battery, there is a problem that the electrode density decreases as the volume occupied by the carbon increases, and the specific capacity of the negative electrode active material also decreases. Further, when the carbon is included in an amount less than 0.5 wt % based on the total amount (100 wt %) of the negative electrode slurry for the lithium metal battery, there is a problem that empty space is formed in the electrode because the particle strength is high and is not completely destroyed by compressing, resulting in a low electrode density. For example, the conductive material may be included in an amount of 0.5 wt % to 20 wt %, for example, 1 wt % to 15 wt %, for example, 5 wt % to 15 wt %, based on the total amount of the negative electrode slurry for the lithium metal battery.

The binder serves to improve the adhesion between negative electrode active material particles and an adhesive strength between the negative electrode active material and the negative electrode current collector. Specific examples may include polyvinylidene fluoride (PVDF), vinylidene fluoride-hexafluoropropylene copolymer (PVDF-co-HFP), polyvinyl alcohol, polyacrylonitrile, carboxymethyl cellulose (CMC), starch, hydroxypropyl cellulose, regenerated cellulose, polyvinyl pyrrolidone, polytetrafluoroethylene, polyethylene, polypropylene, ethylene-propylene-diene monomer rubber (EPDM rubber), sulfonated-EPDM, styrene butadiene rubber (SBR), fluoroelastomer, or various copolymers thereof, and may be used alone or a mixture of two or more thereof. More specifically, it may be polyvinylidene fluoride (PVDF).

For example, based on the total amount (100 wt %) of the negative electrode slurry for the lithium metal battery, the binder may be included in an amount in a range of 0.5 wt % to 20 wt %, for example, 1 wt % to 15 wt %, for example, 5 wt % to 15 wt %.

The negative electrode slurry for a lithium metal battery according to an embodiment may further include a solvent such as THF (tetrahydrofuran), and in addition to THF, the solvent may include, for example, a polar protic organic solvent such as benzyl alcohol, ethylene glycol, n-butanol, isopropanol, n-propanol, ethanol, methanol, and the like; a polar aprotic organic solvent such as NMP (N-methyl pyrrolidone, N-methylpyrrolidone), an ether-based solvent containing a cyano group (for example, ethylene glycol bis(propionitrile) ether (AN2-DME)), a difluoroester solvent, and a monofluoroether solvent, which may be used alone or in combination. In particular, the polar aprotic solvent may contribute to improving the performance of lithium metal batteries by promoting high oxidation stability and excellent solid electrolyte interphase (SEI) layer formation.

According to another embodiment, a method for manufacturing a negative electrode for a lithium metal battery using the negative electrode slurry for a lithium metal battery is provided.

The method for manufacturing the negative electrode for the lithium metal battery includes coating the negative electrode slurry for a lithium metal battery according to an embodiment on a current collector and then drying the negative electrode slurry coated on the current collector to form a coating layer; and compressing the coating layer.

The current collector may include, for example, copper, stainless steel, aluminum, nickel, titanium, calcined carbon, copper or stainless-steel surface-treated with carbon, nickel, titanium, silver, and the like, an aluminum-cadmium alloy, and the like. In addition, the negative electrode current collector may typically have a thickness in a range of 3 μm to 500 μm, and fine unevenness may be formed on the surface of the negative electrode current collector to strengthen the bonding strength of the negative electrode active material. For example, it may be used in various forms such as a film, a sheet, a foil, a net, a porous body, a foam, a non-woven fabric, and the like.

For example, the negative electrode slurry for the lithium metal battery may be coated on the current collector to a thickness in a range of 30 μm to 200 μm, for example, a thickness of 30 μm to 100 μm. By controlling the coating thickness as described above, the thickness of the final compressed coating layer may be easily controlled to a thickness range of 10 μm to 50 μm, which is described below.

For example, the drying may be performed at 60° C. to 120° C. for 12 to 48 hours.

For example, the compressing may be performed using a roll press or the like at a compression ratio of about 40% based on the coating layer, and for example, the compressing may be performed so that the thickness of the coating layer becomes 10 μm to 50 μm. When the thickness of the compressing coating layer is controlled as described above, the cycle performance of a cell assembled using the negative electrode for a lithium metal battery manufactured from it may be significantly improved.

### Negative Electrode for Lithium Metal Battery

According to another embodiment, a negative electrode for a lithium metal battery includes the negative electrode slurry for a lithium metal battery.

Specifically, the negative electrode may be manufactured by the above-described manufacturing method, and in another method, the negative electrode may be manufactured by casting the negative electrode slurry for the lithium metal battery on a separate support, and then laminating the obtained film by peeling it off from the support on a negative electrode current collector.

### Lithium Metal Battery

In another embodiment, a lithium metal battery including the negative electrode is provided.

The lithium metal battery may specifically include a positive electrode, a lithium negative electrode disposed opposite the positive electrode, a separator between the positive electrode and the lithium negative electrode, and an electrolyte, wherein the negative electrode is as described above. In addition, the lithium metal battery may optionally further include a battery container that houses an electrode assembly including the positive electrode, negative electrode, and separator, and a sealing member that seals the battery container.

In the lithium metal battery, the positive electrode may include a positive electrode current collector and a positive electrode active material layer on the positive electrode current collector.

The positive electrode active material layer may optionally include a binder and a conductive material together with the positive electrode active material. The positive electrode active material layer may be manufactured by, for example, coating a composition for forming a positive electrode active material layer, including a positive electrode active material and optionally a binder and a conductive material, onto a positive electrode current collector and drying the composition, or by casting the positive electrode forming composition onto a separate support and then laminating the film obtained by peeling it off from the support onto a negative electrode current collector.

The binder and conductive material may be the same as those described above for the negative electrode.

As described above, the lithium metal battery according to the present disclosure may have an excellent cycle-life and, in addition, may have excellent electrochemical properties, and therefore is useful in portable devices such as mobile phones, laptop computers, and digital cameras, and electric vehicles such as hybrid electric vehicles (HEVs).

The following examples illustrate embodiments of the present disclosure in more detail. However, the following examples are only example embodiments of the present disclosure, and the present disclosure is not limited to the following examples.

Negative electrode slurry for lithium metal battery and negative electrode using the same

After mixing a negative electrode active material (lithium powder having an average particle diameter of 100 μm), a conductive material (carbon black), a binder (PVDF) were mixed in a mass ratio of 80:10:10 to prepare a negative electrode slurry, a portion of carbon black, for example, each amount of 0 wt % (Comparative Example 5), 1 wt % (Example 1), 3 wt % (Example 2), and 5 wt % (Example 3), based on a total solid content in the negative electrode slurry, was replaced with silver (Ag) powder (an average particle diameter: 100 nm).

A solvent used THF (tetrahydrofuran) in an amount in a range of 20% to 60% of the total solid content in the negative electrode slurry, wherein the components were sufficiently stirred, to prepare each the slurry.

The prepared slurry was coated to be 40 μm thick on a copper (Cu) current collector and then, dried under vacuum at 90° C. for 24 hours.

Subsequently, the coating layer was compressed to have a final thickness of about 20 μm by using a roll.

Each negative electrode slurry was prepared in the same manner as above except that silver (Ag) powder having an average particle diameter of 30 nm (Example 4), 50 nm (Example 5), 150 nm (Example 6), 200 nm (Example 7), and 220 nm (Example 8) were respectively used to prepare negative electrode slurries, which were respectively used to manufacture negative electrodes.

In addition, negative electrodes of comparative examples were respectively manufactured by depositing each lithium amount of 0 wt % (Comparative Example 1), 1 wt % (Comparative Example 2), 3 wt % (Comparative Example 3), and 5 wt % (Comparative Example 4) on a commercially available compressed lithium thin film.

### Experimental Example 1

The final electrodes (negative electrodes) were measured with respect to a lithium content (available capacity) for each cycle.

After punching the electrodes (negative electrodes) to 14 pi, a lithium (Li)/copper (Cu) cell capacity evaluation was performed to measure a capacity under conditions of constant current (CC)/constant voltage (CV), 0.05 C, 0.01 C cut-off, and 0 to 1.2 V.

As a result of measuring an initial capacity, all samples were confirmed to exhibit a similar capacity to a theoretical capacity of 3.2 mAh/cm² (refer to Table 1 below).

### Experimental Example 2

Each of the lithium negative electrodes of the examples and the comparative examples proceeded with charge and discharge cycles to measure the number of cycles until 80% of the initial capacity was reached (end of life (EOL)).
Charge: CC-CV, 0.5 C, 0.33 C cut-off, 3 to 4.25 V/discharge: CC, 1 C, 3.0 V cut-off.

Example 2 exhibited the best cell cycle-life, which was superior to those of Comparative Example 5 including no Ag powder and Comparative Examples 1 to 4 manufactured with a different process (refer to Table 1 below).

Examples 1 to 3, which were manufactured by adding silver (Ag) powder to lithium metal powder, exhibited significantly improved cell cycle-life (refer to Table 1 below).

TABLE 1

| | | | | | Cell | |
|---|---|---|---|---|---|---|
| | | | | Lithium | cycle-life | |
| | | Ag | | available | (retention | |
| | Manufacturing | content | Ag addition | capacity | rate 80%, | Increase |
| | method | (wt %) | method | (mAh/cm²) | cycle) | rate |
| Comp. | lithium metal | 0 | — | 3.31 | 132 | — |
| Ex. 5 | powder | | | | | |
| Ex. 1 | lithium metal | 1 | Mixing in slurry | 3.27 | 139 | +5.3% |
| | powder | | | | | |
| Ex. 2 | lithium metal | 3 | Mixing in slurry | 3.34 | 162 | +22.7% |
| | powder | | | | | |
| Ex. 3 | lithium metal | 5 | Mixing in slurry | 3.35 | 161 | +22.0% |
| | powder | | | | | |
| Comp. | compressed | 0 | — | 3.26 | 118 | — |
| Ex. 1 | lithium | | | | | |
| Comp. | compressed | 1 | upper thermal | 3.25 | 121 | +2.5% |
| Ex. 2 | lithium | | deposition | | | |
| Comp. | compressed | 3 | upper thermal | 3.32 | 127 | +7.6% |
| Ex. 3 | lithium | | deposition | | | |
| Comp. | compressed | 5 | upper thermal | 3.30 | 124 | +5.1% |
| Ex. 4 | lithium | | deposition | | | |

### Experimental Example 3

Each of the lithium negative electrodes of Example 2 and Examples 4 to 8, which were manufactured by using silver (Ag) powder with different average particle diameters, proceeded with charge and discharge cycles to measure the number of cycles until 80% of the initial capacity was reached (EOL), and the results are shown in Table 2.

TABLE 2

| | | | | | | Cell |
|---|---|---|---|---|---|---|
| | | | | Ag average | Lithium | cycle-life |
| | | Ag | Ag | particle | available | (retention |
| | Manufacturing | content | addition | diameter | capacity | rate 80%, |
| | method | (wt %) | method | (nm) | (mAh/cm²) | cycle) |
| Ex. 2 | lithium metal | 3 | Mixing in | 100 | 3.34 | 162 |
| | powder | | slurry | | | |
| Ex. 4 | lithium metal | 3 | Mixing in | 30 | 3.31 | 131 |
| | powder | | slurry | | | |
| Ex. 5 | lithium metal | 3 | Mixing in | 50 | 3.26 | 160 |
| | powder | | slurry | | | |
| Ex. 6 | lithium metal | 3 | Mixing in | 150 | 3.25 | 161 |
| | powder | | slurry | | | |
| Ex. 7 | lithium metal | 3 | Mixing in | 200 | 3.32 | 159 |
| | powder | | slurry | | | |
| Ex. 8 | lithium metal | 3 | Mixing in | 220 | 3.30 | 130 |
| | powder | | slurry | | | |

### Experimental Example 4

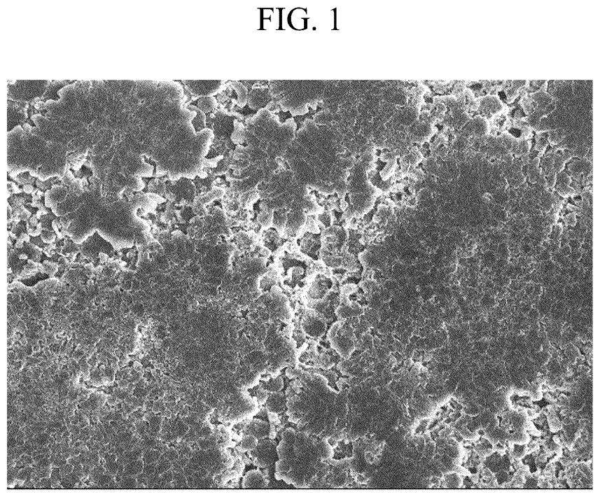

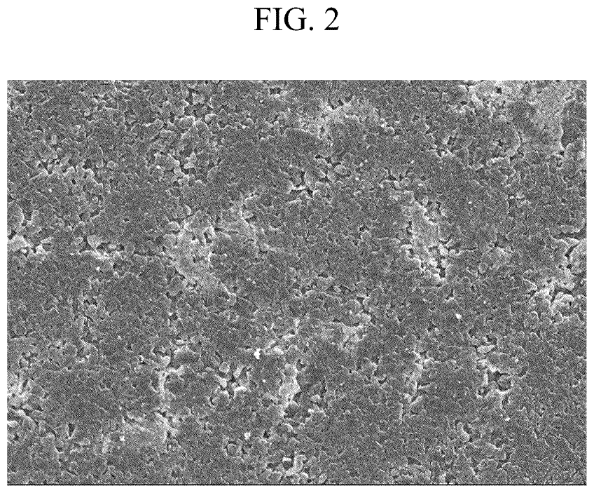

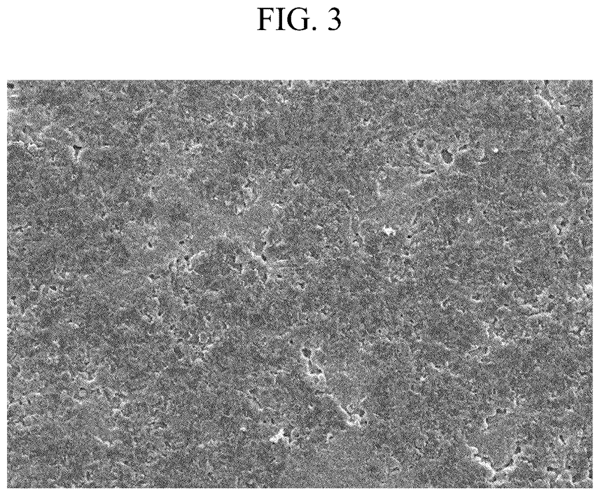

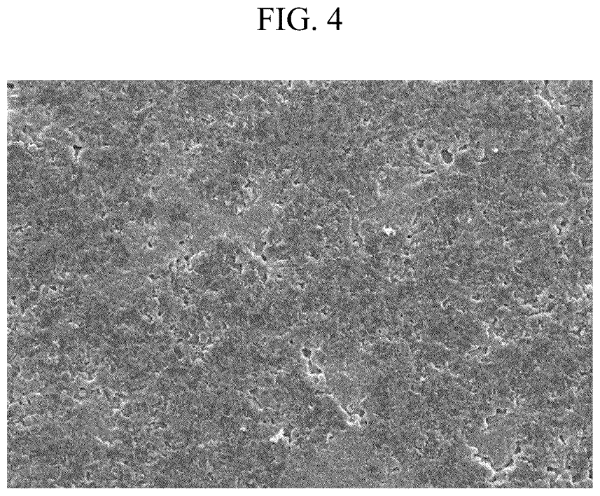

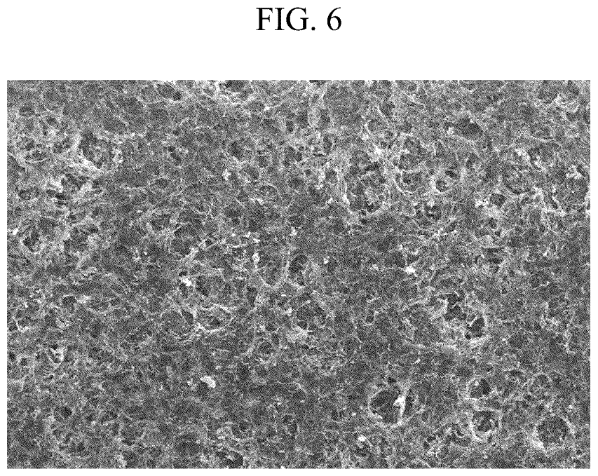

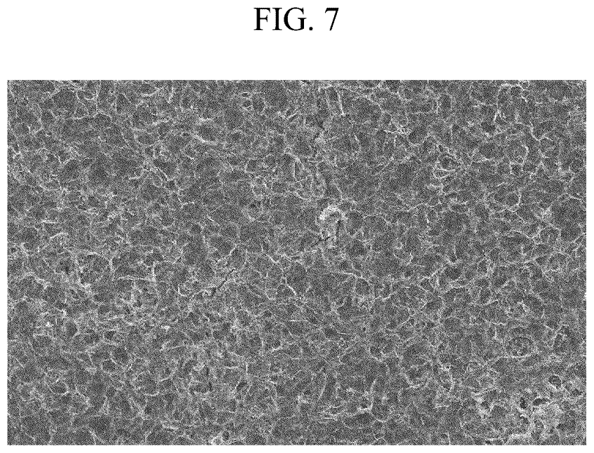

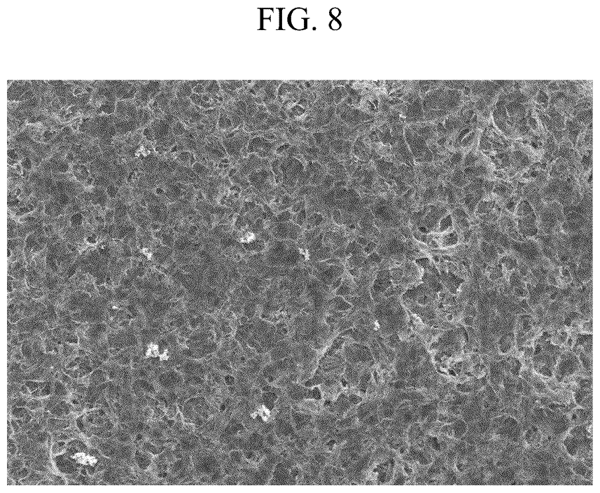

After 10 cycles, the negative electrodes in a charged (lithium electrodeposited) state were taken surface saccning electron microscope (SEM) images of on the surface, and the results are shown in FIGS. 1 to 8.

Referring to FIGS. 1-4, Comparative Example 5, in which silver (Ag) powder was not added, exhibited a region where lithium was not filled, but Examples 1 to 3, which included the silver (Ag) powder, exhibited a more uniform shape, and Examples 2 and 3 exhibited a denser shape.

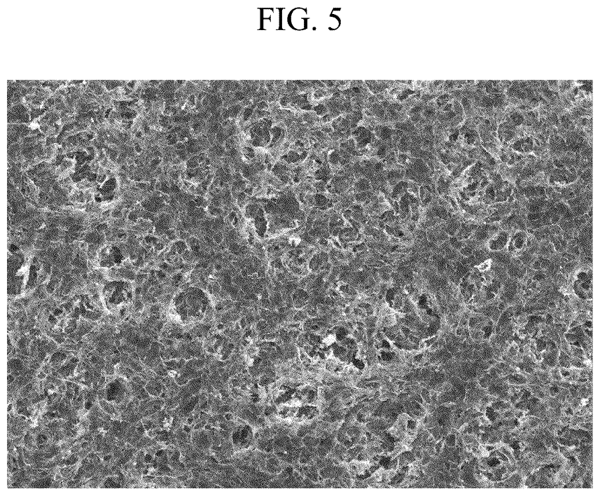

Referring to FIGS. 5-8, Comparative Examples 1 to 4, which used compressed lithium as an electrode, exhibited that the lithium had a porous shape, compared to Examples 1 to 3.

As for Comparative Examples 2 to 4, in which silver (Ag) powder was deposited on the upper surface, Comparative Examples 3 and 4, which had a higher silver (Ag) powder amount, exhibited a denser shape than Comparative Example 1

### Experimental Example 5

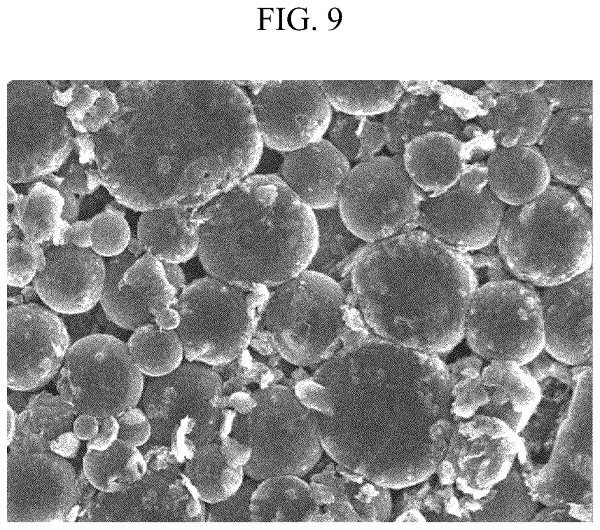

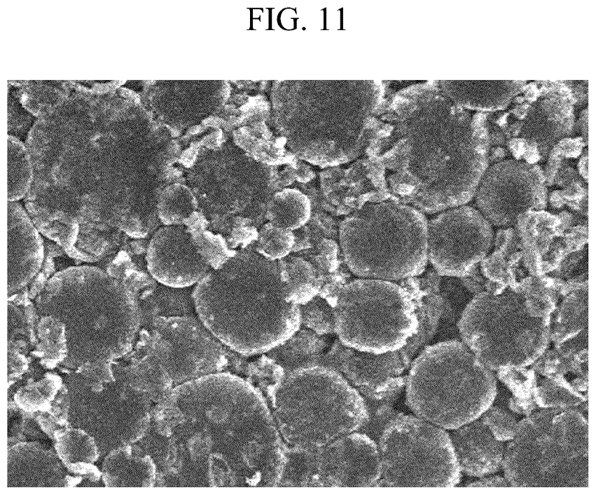

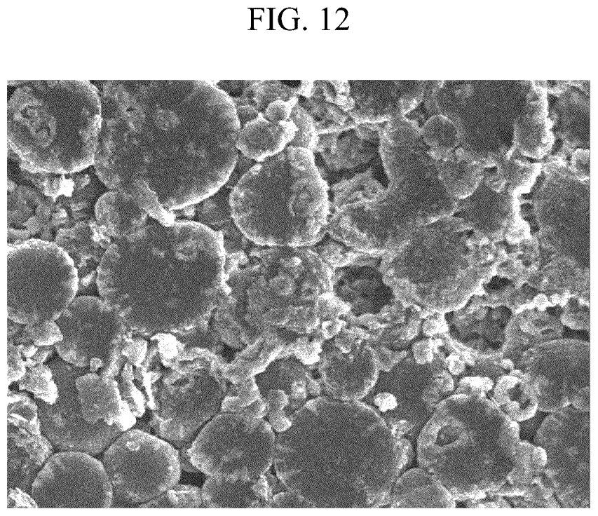

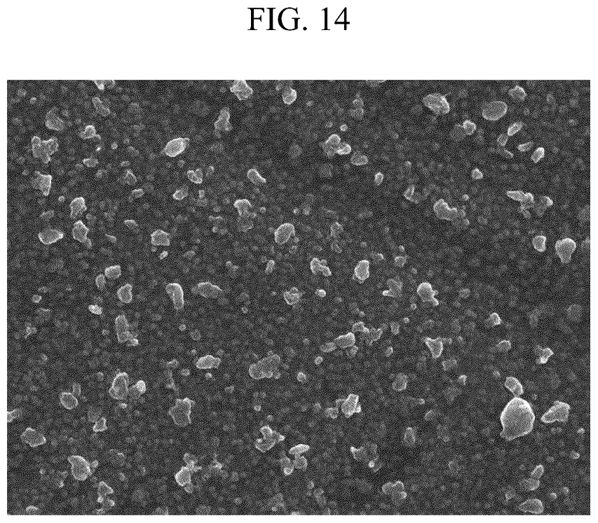

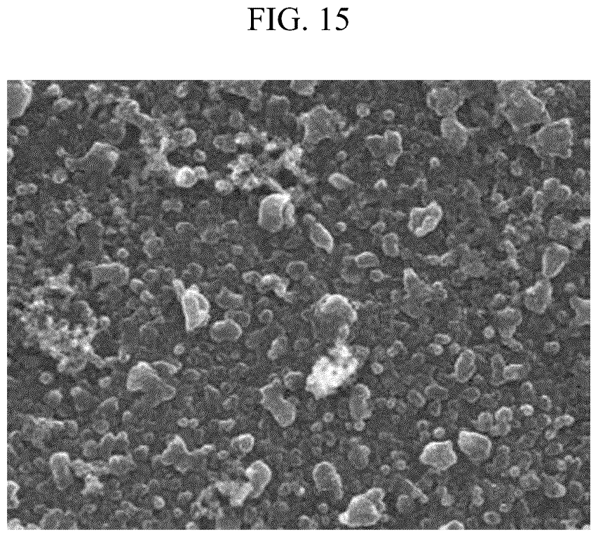

The electrodes in a fresh state after the coating and compressing were taken images of on the surface, and the results are shown in FIGS. 9 to 16.

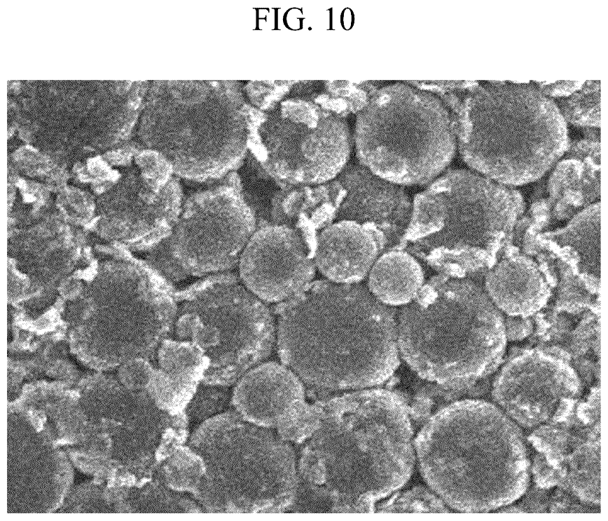

Referring to FIGS. 10-12, in Examples 1 to 3, a lithium powder shape was well expressed, but some carbon or silver (Ag) powder was observed.

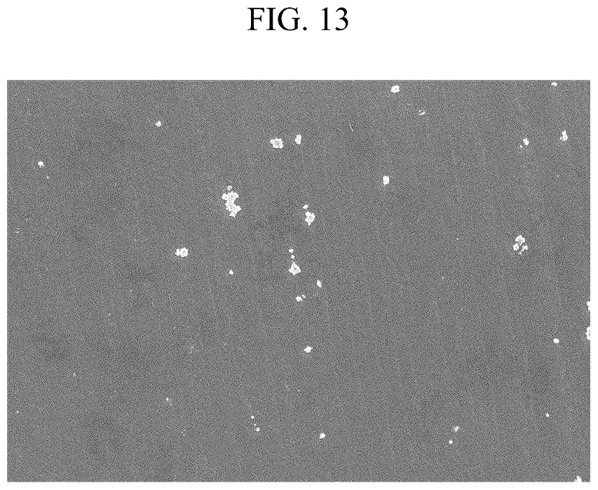

Referring to FIGS. 13-16, in Comparative Examples 1 to 4, a compressed lithium shape was well expressed, but the larger amount of silver (Ag) powder, the more crystal shapes of the silver (Ag) powder on the surface

### Experimental Example 6

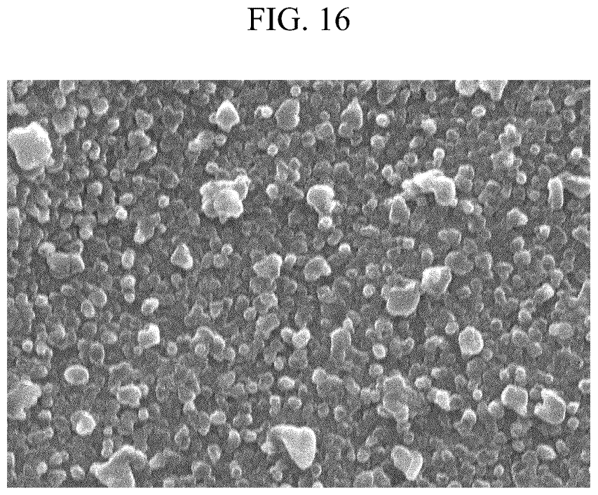

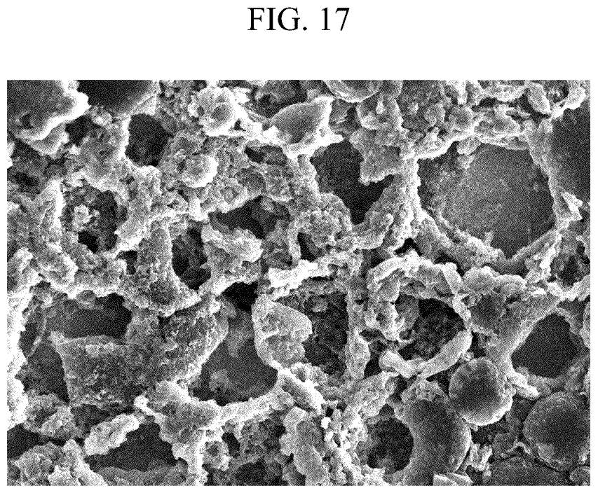

When the electrode of Example 2 was completely discharged (i.e., deintercalate all lithium) and then, subjected to EDS (energy-dispersive spectroscopy) measurement, silver (Ag) powder was detected. (See FIGS. 16 and 17.)

This means that even if charge and discharge were repeated, Ag remained along with carbon (C) and was evenly distributed in the electrode to exert an effect.

While this disclosure has been described in connection with what is presently considered to be practical example embodiments, it is to be understood that the present disclosure is not limited to the disclosed embodiments, but, on the contrary, is intended to cover various modifications and equivalent arrangements included within the spirit and scope of the appended claims. Therefore, the aforementioned embodiments should be understood to be examples but not limiting the present disclosure in any way.

What is claimed is:

1. A negative electrode slurry for a lithium metal battery, the negative electrode slurry comprising:
a negative electrode active material including a lithium powder;
a conductive material;
a binder; and
a metal powder,
wherein the metal powder comprises a silver powder.

2. The negative electrode slurry of claim 1, wherein
the silver powder has an average particle diameter in a arrange of 50 nm to 200 nm.

3. The negative electrode slurry of claim 1, wherein
the silver powder is included in an amount of 1 wt % or more based on a total amount of solids constituting the negative electrode slurry.

4. The negative electrode slurry of claim 1, wherein
the silver powder is included in an amount in a range of 1 wt % to 5 wt % based on a total amount of solids constituting the negative electrode slurry.

5. The negative electrode slurry of claim 1, wherein
the negative electrode slurry includes, based on a total amount of the negative electrode slurry,
60 wt % to 99 wt % of the negative electrode active material,
0.5 wt % to 20 wt % of the conductive material, and
0.5 wt % to 20 wt % of the binder.

6. The negative electrode slurry of claim 1, wherein
the lithium powder has an average particle diameter in a range of 50 μm to 150 μm.

7. The negative electrode slurry of claim 1, wherein
the conductive material comprises carbon black, carbon nanotube, or a combination thereof.

8. A method for manufacturing a negative electrode for a lithium metal battery, the method comprising:
coating a negative electrode slurry for the lithium metal battery on a current collector;
drying the negative electrode slurry coated on the current collector to form a coating layer; and
compressing the coating layer.

9. The method of claim 8, wherein
the current collector is a copper (Cu) current collector.

10. The method of claim 8, wherein
the negative electrode slurry for the lithium metal battery is coated on the current collector to a thickness in a range of 30 μm to 200 μm.

11. The method of claim 8, wherein
drying the negative electrode slurry coated on the current collector is performed at a temperature in a range of 60° C. to 120° C. for 12 hours to 48 hours.

12. The method of claim 8, wherein
compressing the coating layer is performed so that a thickness of the coating layer is in a range of 10 μm to 50 μm.

13. A negative electrode for a lithium metal battery, the negative electrode comprising:
a negative electrode slurry for the lithium metal battery,
wherein the negative electrode slurry includes:
a negative electrode active material including a lithium powder;
a conductive material;
a binder; and
a metal powder, and
wherein the metal powder comprises a silver powder.

14. The negative electrode of claim 13, wherein
the silver powder has an average particle diameter in a arrange of 50 nm to 200 nm.

15. The negative electrode of claim 13, wherein
the silver powder is included in an amount of 1 wt % or more based on a total amount of solids constituting the negative electrode slurry.

16. The negative electrode of claim 13, wherein
the silver powder is included in an amount in a range of 1 wt % to 5 wt % based on a total amount of solids constituting the negative electrode slurry.

17. The negative electrode of claim 13, wherein
The negative electrode slurry includes, based on a total amount of the negative electrode slurry,
60 wt % to 99 wt % of the negative electrode active material,
0.5 wt % to 20 wt % of the conductive material, and
0.5 wt % to 20 wt % of the binder.

18. The negative electrode of claim 13, wherein
the lithium powder has an average particle diameter in a range of 50 μm to 150 μm.

19. The negative electrode of claim 13, wherein
the conductive material comprises carbon black, carbon nanotube, or a combination thereof.
